(19) United States
(12) Patent Application Publication
(10) Pub. No.: US 2003/0018707 A1
(43) Pub. Date: Jan. 23, 2003

(54) Server-side filter for corrupt web-browser cookies

(76) Inventor: Philip Andrew Flocken, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/909,482

(22) Filed: Jul. 20, 2001

(51) Int. Cl. G06F 15/16

(52) U.S. Cl. 709/203; 709/224; 709/225

(57) ABSTRACT

A server that services a number of client computers over an Internet type of a network and that sends cookies to web browsers on those client computers is able to screen out and delete all cookies containing invalid data values. When a client computer web browser submits a request to the server, such as an HTTP request for a web page, the client web browser automatically sends to the server the names and data contents of all cookies that originally came from that server or a related server. The server screens this cookie data contents for illegal data values. If any are found, then when the server next delivers a document to the client web browser, the server inserts into the HTTP header that is associated with the HTML document commands directing the replacement of all named cookies containing erroneous data with new cookies having their expiration dates set to zero so that they are promptly discarded by the client web browser.

### BACKGROUND OF THE INVENTION

1. Field of the Invention

The present invention relates to the management of server data on the client side of a client/server pair that communicate over a network. More particularly, the present invention relates to techniques whereby servers may manage so-called “cookies” deposited by servers on client web browsers over the Internet.

2. Background

Cookies are sets of information that a central Internet web server sends back to a client computer from which the web server has received a query. Later on, when the same client computer sends another query to the same server, the information content of any cookies left behind by that server (saved in file format on the client machine) is returned automatically to the server along with the new query. Accordingly, and without the server having to retain any information relating to the client computer and to earlier queries received from that client computer, the server may respond intelligently to second and subsequent queries in the context of the first and earlier queries.

Cookies containing non-critical information are simply transmitted back to the server along with each and every HTTP query sent to the server, while cookies that contain sensitive or secure information, such as passwords, are transmitted back only if the client computer is using a secure transmission protocol, such as that generated by an HTTPS or SSL query.

There are many ways in which cookies may be used. For example, in the case of web sites receiving a heavy load of incoming queries, cookies make it possible for such sites to employ multiple servers operating in parallel, routing each incoming query to a different server so as to equalize the load on each server. Successive queries from a single client computer are unlikely, in such an environment, to be sent to the same server. In this context, the cookie information appended to and accompanying each query informs each server of the context and past history of each query, just as if all the queries went to a single server which retained a history file of all queries received.

As part of a server's response to a query that is sent back to a client computer, a cookie is introduced into the response by means of an HTTP “Set-cookie:” command, which may be inserted into the HTTP response header for any web page that is sent back to a client computer. Typically, the “Set-cookie:” command originates as part of the HTTP response for a web page that is generated by a program running on the server. The program may be defined by a CGI “script” or by a Java “servlet” running on the server.

Such a “Set-cookie:” command always contains a name for the cookie information that is sent to the client computer. Optionally, a “Set-cookie:” command may also include a cookie expiration date, all or part of the web name (the DNS name or IP address) of the server, part or all of a directory path within the server, and the word “secure” when a cookie's value is only to be returned to the server as part of a secure transmission of the “HTTPS” type.

If one or more cookies are defective, this can cause a client computer to refuse to accept any more cookies from the same server or any other server in that server's network domain, and it can give the appearance that a central web site server is malfunctioning or that another web server in that domain is malfunctioning. Such problems can be cured by means of a cookie deletion program, but existing cookie deletion programs do not distinguish sound cookies from defective cookies and typically must delete all of the cookies on a client computer, even the good ones, thereby disrupting the operating of many servers when the cookies of only one server are defective. Such programs must be downloaded into the client machine in order to function, and the way in which they work must be modified to reflect the particular web browser and operating system, as well as the hardware of the computer, since cookies may be stored differently on different machines for different web browsers or applications.

### BRIEF SUMMARY OF THE INVENTION

The present invention may be briefly described as a server-based method for detecting and eliminating potentially invalid server-supplied data from client web browsers. Following the receipt of a request for services from a client web browser accompanied by server data placed on the client machine by the server or by a related server, the server scans the server data which is received from the client web browser to identify potentially invalid data. It then determines the cookies (or other similar data structures) that may be invalid and sets their expiration fields such that the client web browser will delete them immediately. Then, as part of an HTTP server response sent to the client web browser, the server includes in the response these cookies that contain potentially invalid data, configured for immediate deletion by the client web browser upon receiving them.

This can be done by sending to the client web browser the set of potentially invalid cookies with their data values cleared out by the server program described above; or by adjusting the expiration date of the cookies so that they will expire immediately when received by the client web browser, or both methods may be employed (the data may be cleared from the potentially corrupt cookies and these cookies may additionally be set to expire immediately).

Further objects and advantages of the invention are apparent in the detailed description which follows and in the claims annexed to and forming a part of the specification.

### BRIEF DESCRIPTION OF THE DRAWINGS

FIG. 1 is an overview block diagram of a server and a client computer interconnected by the Internet, where the server includes Java servlets designed to identify and to destroy potentially defective cookies.

FIG. 2 is a table indicating the data structure of a typical cookie.

FIG. 3 illustrates the command format of the “Set-cookie:” command.

FIG. 4 illustrates the formatting of the “Cookie:” string that is optionally sent to a server along with each HTTP web page retrieval request generated by client computer 104 web applications.

FIG. 5 is a block diagram of the “CookieInspector” Java servlet or program.

FIG. 6 is a block diagram of a “CookieEater” Java servlet or program.

### DETAILED DESCRIPTION OF THE INVENTION

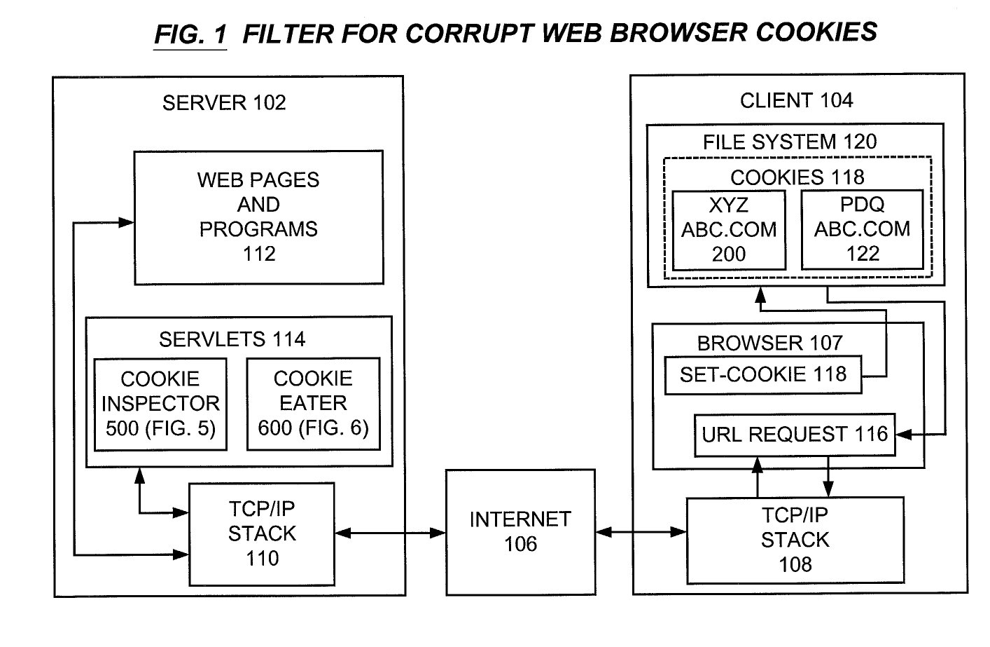

The preferred embodiment of the invention is designed to be installed within servers 102 at web sites servicing client computers 104 over the Internet 106. FIG. 1 presents an overview block diagram illustrating an implementation of the present invention.

With reference to FIG. 1, a server 102 and a client computer 104 are shown interconnected by the Internet 106. The server 102 and the client computer 104 could be in the same room or in the same building interconnected by a simple Ethernet network, or they could be interconnected by a nationwide or a worldwide Internet connection.

The client computer 104 would typically be a IBM compatible or Macintosh portable or desktop personal computer 104. It could just as well be a handheld telephone or personal assistant appliance with a radio link to the Internet. The client computer 104 could also be some form of stand-alone Internet appliance or UNIX workstation.

Both the client computer 104 and the server 102 contain, typically embedded in their operating systems (not shown), network protocol stacks 108 and 110. In the case of the Internet, these stacks would include TCP/IP stacks that are able to establish interconnections between two “sockets,” one on the client computer 104 and one on the server 102. For web communication, socket number 80 is normally used, but a different socket is used in the case of secure communication and perhaps also in the case of communication between handheld devices that use a slightly different protocols in accordance with their special needs.

On the Internet, communication typically begins when some program entity within the client computer 104 wishes to send some form of message to the server 102, typically a request to have a web page downloaded from the server 102 and returned to the client computer 104. Such a request typically begins with “HTTP” followed by “://”, which identifies the request as a “hypertext transfer protocol” request to retrieve a web page from a server 102. What follows next is the “Domain Name” of the server 102, such as “www.abc.com”. This is typically followed by a “path”—a subdirectory name string, such as “/main_directory/ . . . /sub_directory/”—and by the name of the web page document that is being requested for display, for example, “web_page.html”. (The web page document may be a program, and image, a file, or some other downloadable entity.)

That would normally be the end of the message sent to the server 102. However, if the server 102 had previously deposited “cookies” on the client computer 104, the information described above would be followed by a message formulated somewhat like this: “Cookie: XYZ=12345678; PDQ=abcdefg” (see FIG. 4).

The TCP/IP stack 108 within the client computer 104 accepts the above message. The TCP portion of the stack 108 reformats it, as is required by the TCP protocol, by removing the HTTP command prefix and the server name “www.abc.com”. The command prefix “HTTP” is interpreted by the TCP portion as a requirement to establish TCP communication between sockets 80 of the server 102 and the client computer 104. The server name “www.abc.com” is translated (by means of a domain name server or DNS web name lookup request) into the actual 32-bit binary Internet address of the server 102. Next, the TCP portion establishes a temporary bi-directional socket communication channel between port 80 (the usual world wide web port for HTTP communication) on the client computer 104 and port 80 on the server 102. This temporary communication channel interconnects the two TCP/IP stacks 108 and 110 across the Internet 106.

The TCP portion then breaks up the remaining message, if necessary, into one or more shorter packets each containing error detection code, and it passes the short packets to the IP or “Internet protocol” portion of the TCP/IP stack 108 along with the 32-bit Internet address of the server 102. The IP portion then sends out these IP packets over the Internet to the indicated binary address of the server 102, where they are received by the IP portion of the stack 110 and passed to the TCP portion. The complete message is then reassembled by the TCP portion of the stack 110, error checked, and presented to the web program (not shown) within the operating system (not shown) of the server 102, which is set up to receive all incoming TCP messages addressed to socket number 80. The web program then uses the directory and subdirectory path portion of the incoming message, and also the document or program name portion, to find the requested document or program 112 within the server 102's file system. The server 102 then proceeds in accordance with what kind of document or program is identified.

If a true HTML web page has been requested, the web page is simply found at 112 and is returned between the sockets 80 of the two TCP/IP stacks 110 and 108 over the Internet 106 and is displayed by a web browser 107 within the client computer 104. However, there are other possibilities. For example, a form of computer program written in a very high level interpretative language (a “CGI” script) may reside at the designated path and file name address, in which case that program 112 is retrieved and is interpreted and executed by the operating system. Any extra data, such as cookie data, which was appended to the incoming message by the client computer is passed to that program as operating system parameters that can control and affect the program's execution and that can be read into the program as incoming data. Such program might typically retrieve information from a database (not shown), assemble a customized HTML web page, and then return the web page to the browser 107 in the client computer 104 for display.

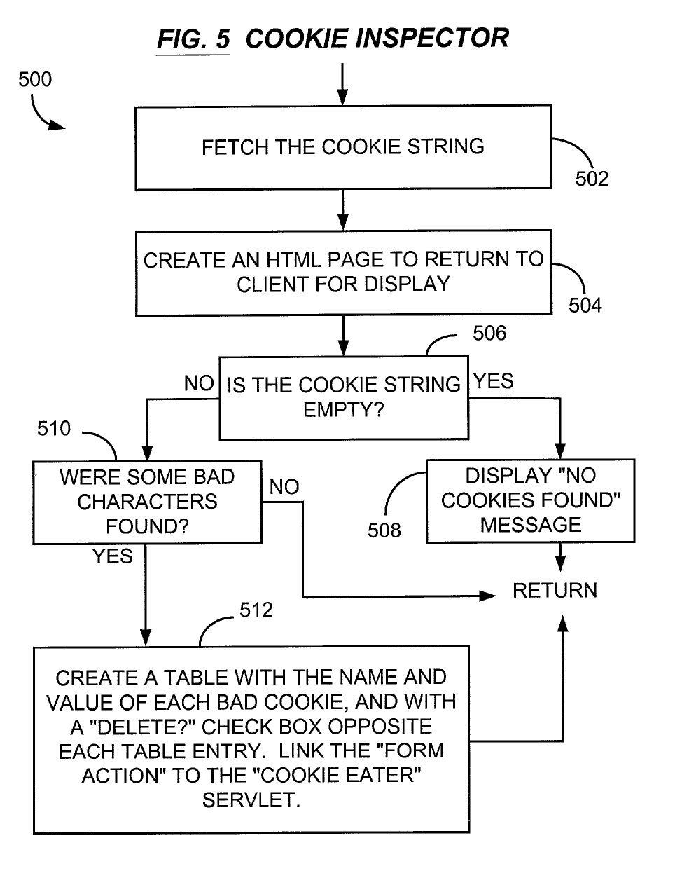

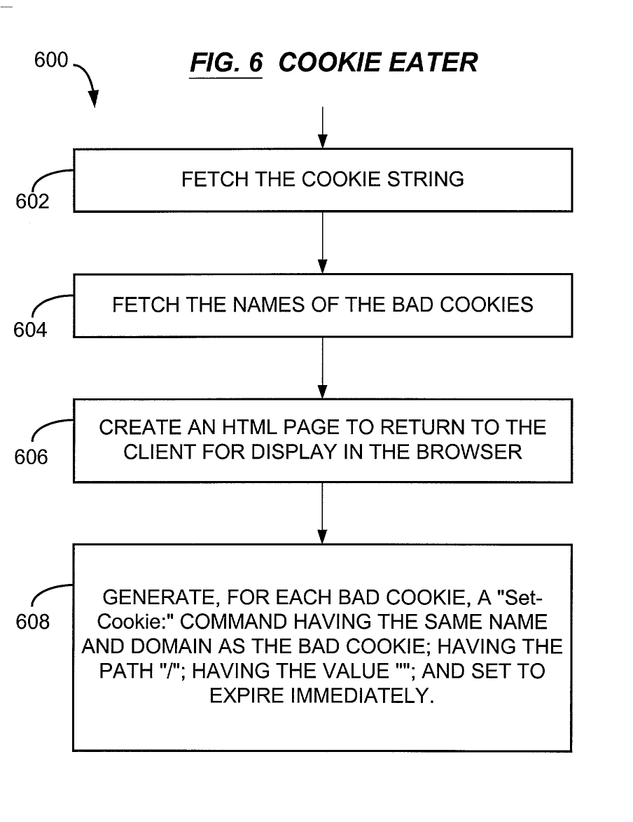

As another possibility, and as is true in the case of the preferred embodiment of the present invention, programs called “servlets” 114 written in the language Java may reside within the server 102 at some locations, and these may also be executed in response to a properly-addressed query received from a client computer 104. Included as servlets shown in FIG. 1 are a “cookie inspector” program 500 and a “cookie eater” program 600, the details of which are disclosed in FIGS. 5 and 6, and illustrative program code for which appears in the respective Appendices A and B of this application.

As can be seen, the browser 107 within the client computer 104, by assisting the user in formulating a proper query for the server 102, is thus able to trigger the execution of programs residing on the server 102, including servlets. The browser 107 typically displays a web page to the user that was downloaded from a server. The user, using a mouse (not shown) or other pointing device, is able to click upon URLs or “Universal Resource Locators” which are web addresses of the type illustrated in FIG. 4 (but possibly lacking the “Cookie: . . . ” suffix) residing within the web page. In response to the user clicking on such a URL in a web page, a URL request 116 (FIGS. 1 and 4) is generated in the format described above. As shown in FIG. 4, the URL request includes information that is derived from cookies such as the cookies 122 and 200 residing on the client computer 104 that contain at least the suffix part or all of the “domain” name of the server 102 to which the URL request is directed and that optionally contain at least the prefix part or all of any designated directory path, as will be explained. Accordingly, once a cookie 118 is installed within the file system 120 of a client computer 104 at the request of a server 102, then any time the user clicks upon a page containing a URL that contains the address of that same server 102, typically all of the cookie information for the server 102 is sent over the Internet and back to the server 102 along with the request for the web page having that corresponds to the URL. Accordingly, if the web page request causes a servlet or interpretative program to be executed, the servlet or interpretative program receives, as part of the incoming message string, the names and the information contents of all the cookies placed into the client computer 104 by that particular server 102.

Whenever a server such as 102 responds and send information back to a client computer such as 104, it may include one or more new or replacement cookies in the response. To place a cookie upon the client computer 104, the server 102 simply transmits back to the client computer 104 an HTML web page, along with the HTTP response header and cookies attached to the response configured with the “Set-cookie:” command (see FIG. 3). This command, and the parameters that follow this command, define the name and the information contents of a cookie. Such commands are detected by the “Set-cookie:” command detector 118 within the browser 107 of the client computer 104, and they are placed into the cookie storage area 118 of the computer 104's file system 120. There they remain until their expiration date is reached (at which time they become inactive) or until the browser 107 sends another request to a server such as 102 whose name appears (in full or in suffix part) within the cookie, at which time the cookie's name and contents are sent along with the message sent to the server 102.

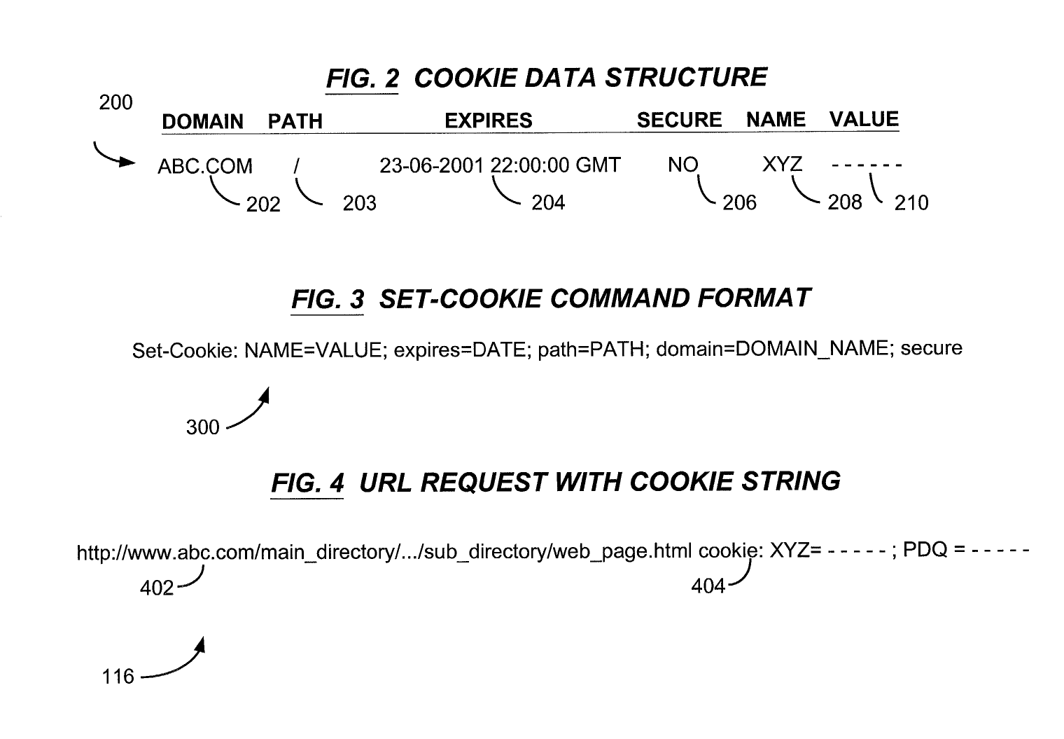

FIG. 2 illustrates in more detail the actual data structure of a cookie. A typical cookie 200 includes a “domain” specification, such as “abc.com”, which specifies the suffix portion or the entirety of the name of all servers 102 to which the cookie is to be returned whenever a request goes out to a server having the specified “domain” as the entirety or as the suffix portion of its Internet name. Thus, the two servers respectively named “www.abc.com” and “www.xyz.abc.com” would both be sent the contents of a cookie whose “domain” parameter was “abc.com” because that domain parameter matches the suffix portions of both of those server Internet names

The cookie also includes a path specification 203, in this case a slash which means no path was specified. Optionally, the path would specify a series of one or directories and sub-directories in the server 102's file system to which this cookie is applicable. Just as the “domain” specification is required to match the suffix portion of a server's Internet name before a cookie is returned to that server, just so the path 203 must also match the prefix portion of the directory path specified in the URL addressed to that server. Accordingly, a path specification can further limit the situations when a particular cookie's information content is sent back to the server 102 along with a URL requesting the retrieval of a document (or the execution of a program) on that server 102.

Each cookie contains an expiration date and time, with the time specified in Greenwich mean time. At 204 in FIG. 2, the date is shown expressed with hyphens, in day-month-year order, and the time is expressed with colons in hour:minute:second order. Cookies are deleted or, at the very least, are no longer sent back to any server (neutralized) by the client computer 104 once their expiration dates have passed. (The term “neutralized” means either deleted or deactivated—no longer returned to the server with client queries.) Also, if the expiration date is set to zero, the cookie is also neutralized. If a date is not specified, then a cookie remains active only until the user's current session with the browser 107 terminates, at which point the cookie is neutralized.

A security command word or code 206 within a cookie indicates whether it must only be transmitted to a server over a secure web link such as that insured, for example, through use of the “HTTPS” secure, encrypted transmission protocol command that most browsers 107 are able to execute with most servers 102. If the security code 206 is “yes” or its equivalent, then the information content of a cookie is never transmitted to a server except when a secure communication path has been requested and established by the browser 107.

Finally, every cookie must have a name 208 and a value 210. The name is a label identifying the particular value that the cookie contains. The value may be anything. However, there are restrictions on which characters may appear within the value portion of a Version 0 cookie. The following characters should not appear within a value portion of such a cookie: space, beginning bracket, end bracket, beginning curly brace, end curly brace, beginning parenthesis, end parenthesis, question mark, plus sign, colon, semi-colon, comma, equal sign, at sign, forward slash, backward slash, and quotation mark. These ASCII characters may appear within a cookie's value, but they cannot be represented in their normal ASCII form. Instead, they must be represented as “%%XX” where the double percent sign is an escape character, and the “XX” indicates, in hexadecimal notation, the number of the ASCII character that is represented by this symbolic form. The “XX” is a two-digit hexadecimal number, where each “X” stands for a digit between zero and nine or a letter between A and F. Accordingly, numbers between “00” and “FF” may be represented in hexadecimal, which correspond to numbers between “000” and “255” in decimal notation. Any ASCII character value may be represented in this manner in the value portion of a cookie.

FIG. 3 illustrates the precise format of the “Set-cookie:” command when it is sent to a browser 107 along with an HTML document as part of the HTTP response header. In FIG. 3, the lower-case words are the words that must actually be used to identify the parameters of a command. The upper-case words are simply space holders for any string of symbols that are appropriate for inclusion in this command. Accordingly, any arbitrary NAME may be equated to any arbitrary VALUE, provided that both the name and value do not include any of the illegal characters listed above. The DATE must be represented as shown in FIG. 2. The PATH and DOMAIN_NAME must be a valid path or path prefix, as in valid directory and sub-directory names conjoined by slashes, and a valid server name or name suffix which may be encountered in future URL requests for documents.

When the web browser 107 generates a URL request at 116 and sends it to a server 102 requesting the downloading of a web page or execution of a program, if the URL-specified server name's suffix matches the “domain” 202 specified by any cookie, and if the URL specified directory and sub-directory's prefix matches the “path” 203 specified by that same cookie, then the name and data value portions of that cookie are automatically sent to the server 102 in the format illustrated in FIG. 4.

In FIG. 4, the URL request 116 generated by the browser 107 requests that the server “www.abc.com” download the web page “web_page.html” to be found at directory and subdirectory path location “/main_directory/ . . . /sub_directory/” using the transfer protocol “HTTP” (hypertext transfer protocol). This URL is indicated at 402 in FIG. 4, and it identifies the server 102 by name and also the specific web page desired plus the directory and sub-directory path on the server 102 that leads to that web page. Appended to the URL 402 at 404, optionally (depending upon the presence of absence of cookies), is a string beginning with the HTTP command word “Cookie:” and followed by a series of one or more equality statements equating the name of a specific cookie with its value, and with multiple such statements, if present, separated by semicolons, as shown, if there is more than one. In this case, the assumption is that the cookie storage area 118 of the file system 120 contains two cookies 122 and 200 which each contain the domain name suffix “abc.com”, one containing the name string “XYZ” and another containing the name string “PDQ” as is shown in FIG. 1. Accordingly, the “Cookie:” command 404 includes two strings, each containing an equal sign, a name, and a value, and separated by a semicolon which are sent along to the server 102 along with the “HTTP://” command prefix and the URL specified at 402 in FIG. 4.

One purpose of the present invention is to find and to delete from the client computer 104 cookies containing potentially erroneous data that may cause the web browser 107 to malfunction in subsequent attempts to access servers in the same domain as the server that sent the potentially corrupt cookie to the client. In the preferred embodiment of the invention, this is done by means of two servlets in the server 102, a first servlet named cookie inspector 500 and a second servlet named cookie eater 600. Of course, other types of inspection and neutralization programs could be substituted for those disclosed here.

There are a variety of ways in which these servlets may be designed and used. For example, in a first embodiment of the invention, a web page (not shown) is retrieved from the server 102 by the client computer 104 and is displayed on the browser 107 to the user. The web page contains a message such as, “To clean bad cookies out of your browser, please click here:” followed by a checkbox that generates a URL request 116 that contains the URL of the cookie inspector servlet 500 on the server 102 when the HTML form containing the checkbox is submitted to the server. When the user clicks on the checkbox, the mechanisms described above transfer control of the Java interpreter within the server 102 to the cookie inspector servlet 500. This servlet is shown in block diagram form in FIG. 5, and the details of an illustrative actual servlet are shown in Appendix A.

Referring to FIG. 5, the cookie inspector servlet 500 begins by fetching the cookie string 404 (FIG. 4) that was passed to the servlet 500 by the operating system and Java interpreter within the server 102 in response to receipt of the cookie information appended to the URL received from the client computer 104, as illustrated in FIG. 4. The servlet 500 then commences to create, at step 504, an HTML page that is returned to the client computer 104 for display. At step 506, the servlet checks to see if any cookie names and data were returned and received by the server 102. If none were returned, then the cookie string is empty, and the servlet, at step 508, displays a “No cookies found” message, which might read as follows:

“No cookies are found in the root cookie path for this domain request.”

“Your browser may not have cookies enabled.”

The servlet then terminates execution and “returns” program control to the web server application, as shown in FIG. 5. This message, contained within displayable hypertext markup language (HTML) page, is returned to the client computer 104 and is displayed by the browser 107.

If, at step 506, the cookie string is found not to be empty, such that there actually are cookie names and values transmitted to the server 102, then the value portions of each cookie string are scanned to see whether or not any improper characters are present at step 510.

The improper characters are the ones listed above (space, equal sign, etc.). If no improper characters are found, then the cookie inspector servlet 50 terminates, possibly sending back a page containing a message to the user stating that the cookies were found to be O.K. However, if any bad characters are found within any cookies, then at step 512, an HTML table is created that contains, on each row, the names and values of each bad cookie with a “delete?” checkbox in front of each row containing a cookie's name and value. The “form action” parameter of this HTML table, which is the name of the web page that is to run in response to the clicking upon any of the form's checkboxes, is set to the URL of the “CookieEater” servlet 600. Then this web page, containing this table, is transmitted to the browser 107 within the client computer 104 and is displayed to the user.

Next, the user reviews the list of bad cookie names and values and clicks, making an X, next to those that are to be deleted. Alternatively, all of the boxes may already contain Xs, and the user then clicks the boxes to cancel the Xs and to indicate which cookies are to be retained in spite of any internal defects. The user then clicks on an “action” button, and the browser 107 transmits a URL request 116 back to the server 102 directed this time to the cookie eater servlet 600 and containing at least the names of the cookies that are to be deleted or otherwise neutralized.

In response to this URL request 116, the server 102 finds and launches the cookie eater servlet 600, which is shown in overview in FIG. 6 and in full detail in Appendix B. The server 102 begins at step 602 by fetching the cookie string listing the name and contents of all of the cookies for the server 102. Next, it fetches the list of the names of the bad cookies that was returned along with the URL request in response to processing of the HTML bad cookie table by the browser 107 at step 604. The cookie eater servlet 600 next creates an HTML page at step 606 that is later returned to the client computer 104 and displayed.

At step 608, the HTTP header for this HTML page contains, for each bad cookie, a “Set Cookie” command, in the format indicated in FIG. 3. Each such command contains a bad cookie's name for its data value, plus a blank value for the cookie; a blank path value, a domain equal to the server 102's name suffix or full name, and also containing the expiration code set to cause the cookie to expire immediately. This HTML page may also include a simple message stating that the bad cookies have been deleted and, optionally, repeating their names and values for the user. This document is then transmitted back to the browser 107 which, in receiving theses new cookies, automatically erases or neutralizes the previous cookies containing the bad values and replaces them with cookies that expire immediately and that contain blank data values.

Other embodiments of the invention are also possible. For example, instead of asking the user's permission to delete bad cookies, the system could check and then delete all bad cookies automatically by running all incoming server messages through the servlet 500 to detect bad cookies and, if necessary, through the servlet 600 to neutralize bad cookies. The servlets would be modified accordingly so as not to ask any questions but simply to report any deleted cookies to the user. The servlets then would pass on the original URL query received from the client computer 104 to the appropriate web page or program within the server 102 for processing, and the user would not necessarily even be aware that any cleanup operations were taking place.

While the invention is shown implemented using servlets written in Java, it could just as well be implemented using interpretative script files such as Perl or Python running on the server 102 or conventional programs written in conventional programming languages, such as C or C++ running on the server 102. And in the second embodiment, the detection and neutralization of invalid cookies could be carried out by a layer added to the TCP/IP stack 110 that filters all incoming messages or otherwise be repositioned within the server 102.

Illustrative versions of the two programs shown in FIGS. 5 and 6 and written in Java appear in the two appendices of this patent application. It should be noted that these have been simplified somewhat to focus only upon the present invention. Details relating to other functions that are not pertinent to the discussion presented here have been deleted from these two illustrative programs.

While the preferred embodiment of the invention has been disclosed, it will be understood by those skilled in the art that numerous modifications and changes will appear to those skilled in the art. Accordingly, the appended claims are intended to cover the true spirit and scope of the present invention.

[image]

[image]

[image]

[image]

[image]

[image]

1. A server-based, computer implemented method for detecting and eliminating invalid server-supplied data from client machines comprising the following steps performed following the receipt of a request for services from a client web browser which request is accompanied by server data placed on the client web machine via commands for the web browser included in transport protocol response headers sent by the server or by related servers on earlier occasions:
scanning the server data which is received from the client web browser to identify invalid data;
determining an identifier that accompanies any data which is invalid; and
as part of a server response sent to the client web browser, including in the response a command or commands that causes only the invalid data, identified by the identifier, to be neutralized.

2. A method in accordance with claim 1, wherein the method is applied to the detection and neutralization of one or more cookies supplied by the server or related servers to client web browsers and, when its data and name is later returned by a particular client web browser to the server, is found to contain invalid data, and wherein only cookies containing invalid data, identified by name, are neutralized.

3. A method in accordance with claim 1, wherein the server data accompanying a request for services received from a client web browser contains one or more separate sets of data each including a name and a data value, and wherein the command or commands sent to the client as part of a response to the client includes one or more commands each of which identifies by name a set of data that contains invalid data and that is to be neutralized, whereby other sets of data containing valid data are not neutralized.

4. A method in accordance with claim 3, wherein neutralization is carried out by sending to a client a command that places on the client a new data set associated with a name for a data set containing invalid data and a domain identifier of the server or of the related servers, the new data set containing no erroneous data, whereby the new data set displaces the erroneous data set and thereby neutralizes the erroneous data set.

5. A method in accordance with claim 1, wherein server data placed on a client machine via commands sent to a client web browser includes an expiration date, and wherein neutralization is accomplished by adjusting the expiration date to a valve that neutralizes the invalid data through expiration.

6. A method in accordance with claim 5, wherein the expiration date is set to zero.

7. A method in accordance with claim 5, wherein the expiration date is set to a date equal to or earlier than the date when the one or more commands is sent back to the client.

8. A method in accordance with claim 1, wherein the invalid data comprises data whose value corresponds to one or more printable character identification codes which match codes contained in a list of invalid character codes.

9. A method in accordance with claim 1, wherein the data transfer protocol is HTTP or an equivalent protocol, the data received comprises one or more data sets preceded by a “Cookie:” command or its equivalent, and separated by semi-colons or some other equivalent separator and of the form “NAME=VALUE” or some equivalent form, and wherein the neutralization of such data is achieved by returning one or more commands “Set-cookie:” or its equivalent, each including at least a first expression followed by one or more expressions, separated by semi-colons or some equivalent separator, of the form “NAME=VALUE” or its equivalent where NAME is the name associated with invalid data and VALUE is valid data which may be no data.

10. A method in accordance with claim 9, in which the command “Set-cookie:” or its equivalent is also followed by an expression “domain=DOMAIN_NAME” or its equivalent where DOMAIN_NAME identifies the server or group of related servers.

11. A method in accordance with claim 10, in which the command “Set-cookie:” or its equivalent is also followed by an expression “expires=DATE” or its equivalent where DATE is a date or its equivalent adjusted to neutralize the invalid data values by the client web browser.

12. A computer program containing instructions enabling it to cause a server to carry out the method steps as in claim 1.

13. A system for detecting and eliminating invalid data from client web browsers comprising:
a server designed to communicate over a network with clients;
a client message receiver and transmitter on the server that is arranged to receive and to process incoming client messages and to transmit return messages back to clients;
a scanner that scans at least some messages flowing into the server coming from clients over the network and including a detector that can detect incoming server data returned to the server by the client and originally supplied to the client on earlier occasions by the server or by a related server;
a data integrity tester that tests the integrity of such incoming server data; and
a message insertion command generator placed into operation when the data integrity tester identifies invalid data in such incoming server data that causes the message receiver and transmitter, when transmitting a return message back to a client from which invalid data was received, to include within the return message one or more commands that causes the client to neutralized the invalid data without neutralizing other valid data.

14. A system in accordance with claim 13, wherein the system is applied to the detection and neutralization of one or more cookies supplied by the server or related servers to client web browsers and, when its data and name is later returned by a particular client web browser to the server, is found to contain invalid data, and wherein only cookies containing invalid data, identified by name, are neutralized.

15. A system in accordance with claim 13, wherein the server data accompanying a request for services received from a client contains one or more separate sets of data each including a name and a data value, and wherein the command or commands sent to the client as part of a response to the client includes one or more commands each of which identifies by name a set of data that contains invalid data and that is to be neutralized, whereby other sets of data containing invalid data are not neutralized.

16. A system in accordance with claim 15, wherein neutralization is carried out by sending to a client a command that places on the client machine a new data set associated with a name for the data set and a domain identifier of the server or of related servers, the new data set containing no erroneous data, whereby the new data set displaces the erroneous data set and thereby neutralizes the erroneous data set.

17. A system in accordance with claim 13, wherein server data placed on a client includes an expiration date, and wherein neutralization is accomplished by adjusting the expiration date to a valve that neutralizes the invalid data through expiration.

18. A system in accordance with claim 17, wherein the expiration date is set to zero.

19. A system in accordance with claim 17, wherein the expiration date is set to a date equal to or earlier than the date when the one or more commands are sent back to the client.

20. A system in accordance with claim 13, wherein invalid data comprises data whose value corresponds to one or more printable character identification codes which match codes contained in a list of invalid character codes.

21. A system in accordance with claim 13, wherein the data transfer protocol is HTTP or an equivalent protocol, the data received comprises one or more data sets preceded by “Cookie:” or an equivalent command and separated by semicolons or an equivalent separator and of the form “NAME=VALUE” or an equivalent form, and where the neutralization of such data is achieved by returning the command “Set-cookie:” or an equivalent command including at least a first expression followed by one or more expressions separated by semicolons or an equivalent separator of the form “NAME=VALUE” or an equivalent form where NAME is the name associated with invalid data and VALUE is valid data or no data.

22. A system in accordance with claim 21, in which the command “Set-cookie:” or its equivalent is also followed by an expression “domain=DOMAIN_NAME” or an equivalent expression, where DOMAIN_NAME identifies the server or group of related servers.

23. A system in accordance with claim 22, in which the command “Set-cookie:” or its equivalent is also followed by an expression “expires=DATE” or an equivalent expression, where DATE is a date value or its equivalent adjusted to neutralize the data value at the client.

24. A system in accordance with claim 21, in which the command “Set-cookie:” is also followed by an expression “expires=DATE” where DATE is a date adjusted to neutralize the data value by the client browser.
